(19) United States
(12) Patent Application Publication
(10) Pub. No.: US 2025/0042364 A1
(43) Pub. Date: Feb. 6, 2025

(54) WINDSHIELD WIPER SYSTEMS

(71) Applicant: Tesla, Inc., Austin, TX (US)

(72) Inventors: Daniel Nashed, San Jose, CA (US); Maithreya Kedambadi, Redwood City, CA (US)

(21) Appl. No.: 18/717,127

(22) PCT Filed: Dec. 2, 2022
(86) PCT No.: PCT/US2022/051647

§ 371 Date: Jun. 6, 2024

Related U.S. Application Data
(60) Provisional application No. 63/265,021, filed on Dec. 6, 2021.
(60) Provisional application No. 63/269,932, filed on Mar. 25, 2022.

(51) Int. Cl. B60S 1/34; B60S 1/08

(52) U.S. Cl. CPC B60S 1/3406; B60S 1/08

(57) ABSTRACT

A wiper system for wiping a, windshield includes a first wiper arm and a second wiper arm both supporting at least one wiper blade. A wiper motor drives rotation of the first wiper arm. An actuator is coupled eccentrically to the second wiper arm so as to convert rotary motion of the actuator to reciprocating motion of the second wiper arm. A pantograph wiper system of a vehicle includes a first wiper arm configured to be driven by a first pivot drive shaft, a second wiper arm configured to be driven by a second pivot drive shaft, and a single wiper motor. The single wiper motor drives rotation of the first and second pivot drive shafts. An arm-blade coupler connecting a wiper middle arm to the first and second wiper arms so as to allow the wiper middle arm to slide along the first and second wiper arms.

### CROSS-REFERENCE TO RELATED APPLICATIONS

This application claims the benefit of U.S. Provisional Application No. 63/265,021, filed Dec. 6, 2021, and U.S. Provisional Application No. 63/269,932, filed Mar. 25, 2022, the entire disclosure of each is hereby incorporated by reference in its entirety.

### TECHNICAL FIELD

Various embodiments of the disclosure relate to a windshield wiper system for a vehicle. Various embodiments of the disclosure relate to a wiper system that can reduce drag on the vehicle and/or vary an angle of attack of a wiper blade against a windshield. Various embodiments of the disclosure relate to a slider-crank wiping mechanism with variable curvilinear blade sweep that increases the maximum allowable wiping sweep of the pantograph wiper system for enhanced windshield cleanability.

### BACKGROUND

Advancements in the field of windshield cleaning systems and ergonomic vehicle design have led to an increase in the demand for windshield wiper systems that are not only effective in cleaning windshields (e.g., operational) but are also effective in reducing drag and wind noise on the vehicle when non-operational. In certain scenarios, the wiper arm and blade can have a relatively large size and be oriented against the direction of air streamlines flowing across the vehicle. In such a situation, excessive drag force and wind noise can be created due to the change in direction and separation of airflow as the airflow comes in contact with the wiper arm and blade resting on the windshield. Conventional pantograph and 4-bar link windshields are large and bulky by design and hence present additional challenges to aerodynamics. There is a need for windshield wiper systems that address the aforementioned drawbacks.

Windshield wiper systems are vital constituents to vehicle safety as they directly impact the operational capability of the driver inside the vehicle during hazardous environments, including but not limited to rain, drizzle, hail, snow, ice pellets (and/or crystals), and sandstorms. To that effect, a great deal of attention is needed to ensure that wiper systems are effective in providing sufficient windshield cleanability, as dictated by numerous vehicle safety standards and regulations.

### SUMMARY

An aspect is directed to a wiper system for wiping a windshield. The system can comprise a first wiper arm and a second wiper arm both supporting at least one wiper blade. A wiper motor drives rotation of at least the first wiper arm. An actuator coupled eccentrically to the second wiper arm converts rotary motion of the actuator to reciprocating motion of the second wiper arm.

A variation of the aspect above further comprises a controller configured to control rotational motion of at least the actuator so as to cause selective rotation of the at least one wiper blade relative to the first wiper arm and the second wiper arm.

A variation of the aspect above is, wherein the selective rotation is to a park position.

A variation of the aspect above is, wherein the selective rotation steers the at least one wiper blade as the at least one wiper blade traverses the windshield.

A variation of the aspect above is, wherein the selective rotation sets the at least one wiper blade at a pre-defined angle of orientation.

A variation of the aspect above is, wherein the selective rotation changes an angle of inclination of the first wiper arm and the second wiper arm as the at least one wiper blade traverses the windshield.

A variation of the aspect above further comprises a drive crank coupled between the actuator and the second wiper arm.

An aspect is directed to a wiper assembly for pantograph or 4-bar link style wipers. The pantograph or 4-bar link style wipers have a first wiper arm and a second wiper arm both supporting at least one wiper blade. The wiper assembly comprises a wiper motor configured to drive rotation of the first wiper arm and drive rotation of the second wiper arm via the first wiper arm across a windshield. An actuator is coupled to the second wiper arm and configured to extend and retract the second wiper arm in a direction that is generally perpendicular to a direction of motion of the first wiper arm.

An aspect is directed to a wiper system for pantograph or 4-bar link style wipers. The pantograph or 4-bar link style wipers have a first wiper arm and a second wiper arm both supporting at least one wiper blade. The wiper assembly comprises a wiper motor having a drive shaft coupled to the first wiper arm, a rotational actuator having a drive crank and an idler shaft, the idler shaft being coupled to the second wiper arm, and a controller configured to control rotational motion of the drive shaft and of the rotational actuator so that the first and second wiper arms are steered, back and forth across a length of a windshield.

A variation of the aspect above is, wherein the controller is configured to position the wiper blade at pre-defined angle of orientation on the windshield.

A variation of the aspect above is, wherein the controller is configured to re-adjust a position of the idler shaft to change an angle of inclination of at least the wiper blade with respect to a reference axis during transverse motion of the first and second wiper arms across the length of the windshield.

An aspect is directed to a pantograph wiper system of a vehicle. The pantograph wiper system has a first pivot drive shaft, a first wiper arm configured to be driven by the first pivot drive shaft, a second pivot drive shaft, a second wiper arm configured to be driven by the second pivot drive shaft, a wiper motor configured to drive rotation of the first and second pivot drive shafts, an idler pivot shaft coupled to one of the first or second pivot drive shafts, a wiper middle arm, a reciprocating crank and a reciprocating shaft configured to transmit rotational motion of the idler pivot shaft to the wiper middle arm, and an arm-blade coupler connecting the wiper middle arm to the first and second wiper arms, the arm-blade coupler being configured to allow the wiper middle arm to slide along the first and second wiper arms.

A variation of the aspect above is, wherein each of the first and second wiper arms comprises a track, and wherein the arm-blade coupler comprises a plurality of rollers configured to slide up and down along a length of each track.

A variation of the aspect above further comprises a wiper blade coupled to the wiper middle arm, wherein a sweep of the wiper blade has a variable curvilinear shape.

A variation of the aspect above is, wherein rotational motion of the first and second wiper arms is synched with linear motion of the arm-blade coupler.

A variation of the aspect above is, wherein the wiper motor is a single wiper motor.

A variation of the aspect above further comprises a gear train.

A variation of the aspect above is, wherein the gear train compromises a drive gear and an idler gear.

A variation of the aspect above is, wherein a ratio provided by the gear train is two.

A variation of the aspect above is, wherein the gear train is configured to propel the reciprocating crank and the reciprocating shaft at twice a rotational speed of the first and second drive pivot shafts in an opposite direction.

A variation of the aspect above is, wherein a rotational motion of the reciprocating crank and the reciprocating shaft is converted to linear motion of the plurality of rollers.

An aspect is directed to a wiper system. The wiper system has a wiper motor, a first wiper arm and a second wiper arm configured to be driven by the wiper motor, a wiper middle arm, and an arm-blade coupler connecting the wiper middle arm to the first and second wiper arms, the arm-blade coupler being configured to allow the wiper middle arm to slide along the first and second wiper arms.

A variation of the aspect above is, wherein the wiper motor is a single wiper motor.

A variation of the aspect above is, wherein the wiper middle arm slides along at least a portion of a length of the first and second wiper arms.

A variation of the aspect above is, wherein each of the first and second wiper arms comprises a track, and wherein the arm-blade coupler comprises a plurality of rollers configured to slide up and down along a length of each track.

A variation of the aspect above is, wherein the wiper system is configured as a pantograph wiper system.

A variation of the aspect above further comprises a wiper blade coupled to the wiper middle arm, wherein a sweep of the wiper blade has a variable curvilinear shape.

A variation of the aspect above is, wherein rotational motion of the first and second wiper arms is synched with linear motion of the arm-blade coupler.

A variation of the aspect above further comprises a gear train.

A variation of the aspect above is, wherein the gear train compromises a drive gear and an idler gear.

A variation of the aspect above is, wherein a ratio provided by the gear train is two.

A variation of the aspect above is, wherein the gear train is configured to vary a speed ratio between the first and second wiper arms and the middle arm.

A variation of the aspect above is, wherein the gear train is configured to control an angular position of the middle arm with respect to first and second wiper arms.

An aspect is directed to a method for wiping a windshield. The method comprises providing at least one wiper blade supported by a first wiper arm and a second wiper arm, rotating at least the first wiper arm, and converting rotary motion to reciprocating motion of the second wiper arm.

A variation of the aspect above further comprises controlling the rotary motion so as to cause selective rotation of the at least one wiper blade relative to the first wiper arm and the second wiper arm.

A variation of the aspect above is, wherein the selective rotation is to a park position.

### BRIEF DESCRIPTION OF THE DRAWINGS

The present inventions are described with reference to the accompanying drawings, in which like reference characters reference like elements, and wherein:

FIG. 1 is a block diagram that includes a wiper system for a vehicle in accordance with an embodiment of the present disclosure.

FIG. 2 is an exemplary illustration of the vehicle that includes the wiper system of FIG. 1 resting against a windshield.

FIG. 3 is a plan view of the windshield from FIG. 2 and illustrates a wiper blade of the wiper system of FIG. 1 aligned with a left edge of a wiped region of the windshield.

FIG. 4 is a side view of the windshield from FIG. 3 and illustrates the wiper blade of the wiper system moved to a resting or parked position on the windshield.

FIG. 5 illustrates exemplary vision zones that are required to be wiped by the wiper system of FIG. 1 per regulatory requirements.

FIG. 6 illustrates a first park position for the wiper blade and/or arms that obstructs airflow across the windshield.

FIG. 7 illustrates a second park position for the wiper blade and/or arms that improves the airflow across the windshield as compared to FIG. 6.

FIG. 8 is a perspective view of a portion of the wiper system of FIG. 1 that shows a drive shaft and an idler shaft.

FIG. 9 is a top view of the portion of the wiper system from FIG. 8.

FIG. 10 illustrates a series of views (left to right) showing exemplary steps for moving the wiper blade from an operational position to a non-operational or parked position.

FIG. 11 illustrates an attack angle optimization technique performed by the system of FIG. 1 to reorient the wiper blade on the windshield surface during dynamic wiping conditions (e.g., operational).

FIGS. 12 and 13 are drawings that depict a slider-crank wiping mechanism with variable curvilinear blade sweep for a pantograph wiper system from an isometric point of view, in accordance with an embodiment of the present disclosure.

FIG. 14 is a top view of the slider-crank wiping mechanism from FIG. 12.

FIG. 15 is a side view of the slider-crank wiping mechanism from FIG. 12.

FIG. 16 is a rear view of the slider-crank wiping mechanism from FIG. 12.

FIG. 17 shows a pantograph wiper system with the slider-crank wiping mechanism installed on a vehicle with a large height-to-width windshield dimensions as well as typical vision zones that need to be covered by the wiper system as per regulatory requirements.

FIG. 18 provides a comparison between the wiping sweep of a traditional pantograph wiper system versus that of a pantograph wiper system with the slider-crank wiping mechanism.

FIG. 19 illustrates three different positions of a pantograph wiper system with the slider-crank wiping mechanism as it sweeps across the windshield.

FIG. 20 illustrates the extrema positions of a pantograph wiper system with the slider-crank wiping mechanism on a windshield with a large height-to-width aspect ratio.

FIG. 21 illustrates the wiping sweep of a traditional pantograph wiper system on three different windshield sizes: a height-to-width aspect ratio close to one, a height-to-width aspect ratio significantly smaller than one, and a height-to-width aspect ratio significantly larger than one.

FIG. 22 illustrates SAE Vehicle Safety Recommended Practice J942 standards for the minimum wiped area requirements as a percentage of three different vision zones, defined by four planes projecting from the eyellipse at certain angles.

FIG. 23 includes a table that compares the effective wiping sweep of the pantograph wiper system disclosed herein versus a traditional pantograph wiper system for a hypothetical windshield with a large height-to-width ratio.

### DETAILED DESCRIPTION

Generally described is a wiper system that provides a park position for the wiper blade in a first mode of operation. In a second mode of operation, the wiper system can vary an angle of attack for the wiper system when wiping the windshield. The positioning of the wiper system can be selected to be aerodynamic.

The wiper system may have a modular architecture that can be readily installed on a vehicle. In certain embodiments, the wiper system includes a wiper motor and an actuator. The wiper motor can drive rotation of a first wiper arm and indirectly drive rotation of a second wiper arm via the first wiper arm. The wiper arms can be coupled to each other to form a single wiper which supports a wiper blade in a pantograph design set-up. An actuator coupled to the second wiper arm can at least in part reciprocally move the second wiper arm to park and/or change an angle of attack for the wiper blade. In certain embodiments, the wiper system syncs movement of the drive shaft and the idler shaft.

The wiper system may further include a controller that controls the relative motion and position of the idler shaft with respect to the drive shaft. The relative motion of the idler shaft, via a drive crank, may be controlled to steer one of the wiper arms back and forth across a narrow portion of the windshield to reorient the wiper blade in the direction of the airflow streamlines during wiping as well as move the wiper blade to a park position during non-operation of the wiper system. This may result in reduced drag generation and airflow separation at the sides of the windshield where low pressure areas are created as the vehicle is in motion. Alternatively stated, the wiper system may utilize the adjustment in idler shaft position to reorient the wiper arms relative to the windshield during wiping operation on the basis of improving the attack angle of the wiper arms and wiper blade relative to the windshield surface and/or park the wiper blade during non-operation.

In certain embodiments, the controller can optimize the relative angle of the wiper arms with respect to a reference axis as the drive shaft sweeps the wiper arms across the windshield according to a pre-determined operating wipe angle. Such continuous, time-based control of the wiper arms during the wiping operation can enhance the cleaning capability of the wiper blade in the second mode of operation. As a result, the wiper system has the ability to minimize wind-noise, increase driving range of the vehicle, and provide improved cleaning operation of the windshield.

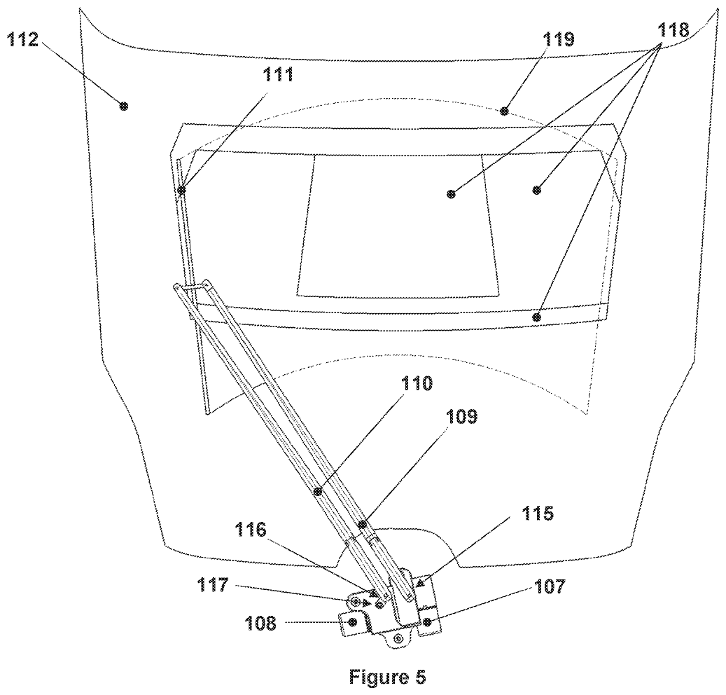

Conventional pantograph and 4-bar link windshield wiper systems create an eccentric wipe arc pattern usually to accommodate the regulatory wiper zone coverage requirements of a highly skewed height-to-width aspect ratio of windshield design (See FIG. 5). The large exposed surfaces of the wiper arms and wiper blade can become a detriment to aerodynamics of the vehicle because they are not oriented to take into account oncoming air flow lines. Since wiper systems are intermittently used on the vehicle, in that, they're used under only under certain conditions such as deposition of rain, dust, salt or other contaminants on the windshield which gives rise to poor visibility. Thus, during a majority of driving time the wiper systems are parked in a resting position that generates significant drag force for the vehicle. To overcome the additional drag force, the vehicle expends additional power which decreases vehicle efficiency and range. Embodiments of the wiper system disclosed herein can provide an optimized park position for the wiper arms and/or wiper blade in the first mode of operation.

In certain embodiments, the wiper systems disclosed herein can adapt to accommodate complex windshield curvatures and varying windshield surface profiles. In certain embodiments, the wiper system disclosed herein can adjust or vary the position of the wiper blade relative to the wiper arms as the wiper arms traverse the windshield in a back and forth motion during the second mode of operation. In certain embodiments, the position of the wiper blade relative to the wiper arms can be continually changed. In certain embodiments, the positioning of the wiper blade relative to the wiper arms when traversing the windshield in a first direction is different than when the wiper blade is moving in a second direction opposite the first direction. In certain embodiments, the wiper system disclosed herein continuously adjusts an attack angle and traverse orientation of the wiper blade to improve wiping results.

Standards and regulations provide minimum requirements for the wiped area as a percentage of the windshield vision zones pertaining to each unique vehicle. The vision zones are specific areas on the windshield glazing surface, constructed by four imaginary planes projecting out of a point inside the vehicle called the “eyellipse” which statistically represents the driver's eye location. The four projected planes out of the eyellipse intersect the windshield glazing surface to form the top, down, left, and right peripherals of each vision zone. Hereinafter, the minimum wiped area, expressed as a percentage of the vision zone, is established to provide the minimum viewing requirements necessary to operate the vehicle. One such requirement is provided by the SAE Vehicle Safety Recommended Practice J942.

Traditional pantograph wiper systems are ideal for semi-trucks, heavy trucks and buses which moderately resemble the dimensions of a regular quadrilateral because they provide the maximum effective wiped pattern (or wiping sweep as it shall be referred to in this document) as a percentage of the vision zones when compared to other wiper systems like four-bar linkage wiper systems. They also consume the least packaging space in a vehicle environment since they do not possess large linkages in motion as can be seen in four-bar linkage wiper systems. In certain vehicles, however, a significant deviation in the windshield shape from a regular square shape can skew the symmetrical balance between the top-down periphery and the left-right periphery of the vision zones, rendering the traditional pantograph wiper system ineffective in providing the maximum wiping sweep, or in some cases, even failing to meet the minimum wiped area requirements.

In windshields where the height-to-width aspect ratio is substantially less than one, the summation of the left and right angles of the two planes projected out of the eyellipse exceeds the summation of the top and down angles of the two planes projected out of the eyellipse. This results in a skewed vision zone that requires a wiping sweep with a larger width in relation to height. In this scenario, either a four-bar linkage wiper system is the more appropriate arrangement to use (which is more complex and occupies more packaging space) or two pantograph systems in tandem are used (which doubles the cost of the wiper system). In contrast, where the height-to-width aspect ratio is significantly greater than one, a pantograph wiper system with longer wiper arms and longer blade is necessary to provide a wiping sweep that is longer in height than it is in width. However, such a system would suffer from uneven force distribution along the length of the blade unless a bulky whippletree mechanism is employed which would increase the cost, complexity, and mass of the blade. This inadequate force distribution would in consequence decrease the cleanability performance of the wiper system. Moreover, due to a longer and heavier arm and blade assembly, a greater moment arm would act on the pivot axis of the wiper motor which ultimately increases the torque specifications and voltage specifications of the wiper motor, leading to a considerably more expensive wiper system. Pantograph wiper system that addresses the wiping sweep limitations of the existing traditional pantograph wiper system are disclosed herein.

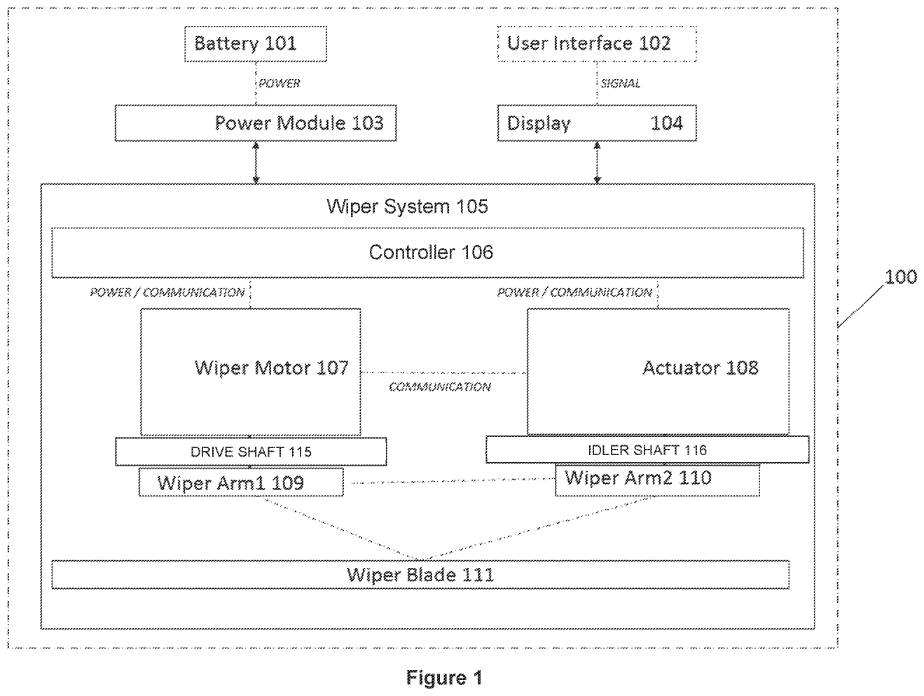

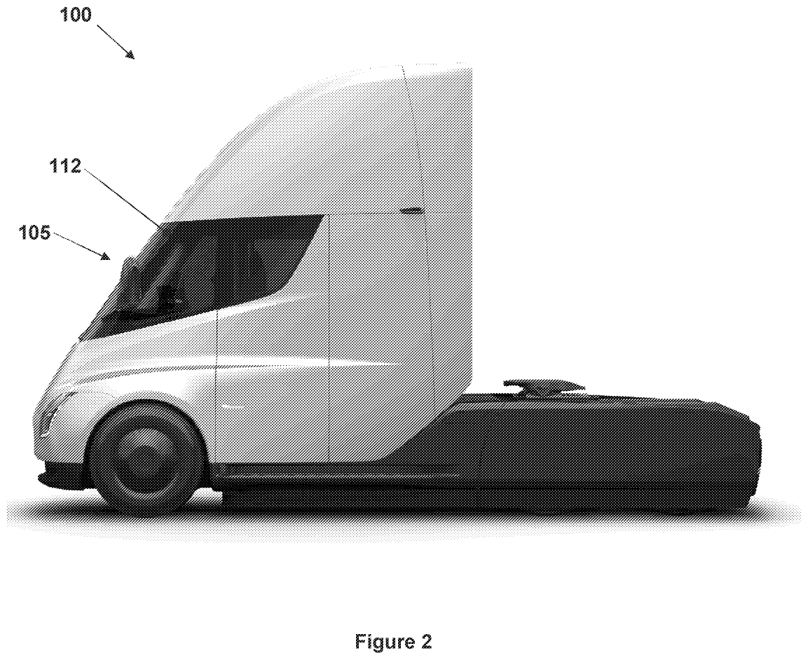

FIG. 1 is a block diagram of a vehicle 100 that includes a wiper system 105 in accordance with an embodiment of the present disclosure. FIG. 2 is an exemplary illustration of the vehicle 100 from FIG. 1 that includes the wiper system 105 of FIG. 1 resting against a windshield 112. The vehicle 100 may be an electric vehicle, a hybrid vehicle, an ICE vehicle, a vehicle with driver-assist capabilities, and/or a vehicle with autonomous-drive capabilities. In embodiments, the vehicle 100 may be an air-borne vehicle, a water-borne vehicle, or a hybrid of an air-borne, or a land-borne vehicle.

In certain embodiments, the vehicle 100 includes a display 104 and a user interface 102 for the display 104. In certain embodiments, the display 104 may comprise suitable logic, circuitry, interfaces, and/or code that renders various types of information and controls via the user interface (UI) 102. In certain embodiments, the UI 102 may be a customized graphical user interface (GUI) that displays the various types of information, controls, or settings to operate the wiper system 105. In certain embodiments, the wiper system 105 may also be controlled or operated by a hardware control button or a wiper switch provided in the vehicle steering stalk. In certain embodiments, the display 104 may be a touch screen that receives an input from the user of the vehicle 100. Examples of the display 104 include, but are not limited to a display of the infotainment head unit, a projection-based display, a see-through display, and/or an electro-chromic display.

In certain embodiments, the vehicle 100 comprises a power module 103 and a battery or a battery-pack 101 for the power module 103. In certain embodiments, the battery 101 may be a rechargeable source of electric power for one or more electric circuits or loads (not shown), necessary for operation of the wiper system 105 and the display 104 of the vehicle 100. In some embodiments, instead of a single battery, the battery-pack 101 has a plurality of batteries arranged in a planar or non-planar array to power the vehicle 100.

In certain embodiments, the power module 103 may regulate the charging and the power output of the battery 101 to various electric circuits and the loads of the vehicle 100, such as the wiper system 105 and the display 104. In certain embodiments, the power module 103 may include power electronics.

In certain embodiments, the wiper system 105 comprises a controller 106 (e.g., electronic control unit (ECU)). In certain embodiments, the power module 103 may be communicatively connected to the controller 106 to receive control signals from the controller 106 to modulate the current and power distribution for different operational components of the wiper system 105. In certain embodiments, the controller 106 controls a plurality of operational parameters of the wiper system 105. In certain embodiments, the controller 106 controls the plurality of operational parameters of the wiper system 105 based on the adaptive modulation of the power and current to the different operational components of the wiper system 105. Exemplary parameters include, but are not limited to, the operating drive angle and angular velocity of the actuator 108, the pre-calibrated angle of inclination of a wiper arm 109, 110 of the wiper arrangement (or a change in the angle of inclination), and the movement frequency of the two wiper arms 109, 110.

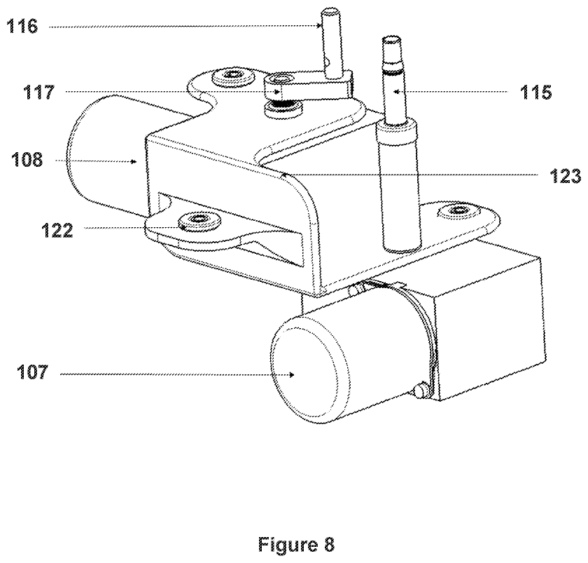

As shown in FIG. 1, the wiper system 105 can comprise a wiper motor 107 and an actuator 108. In certain embodiments, the actuator 108 comprises an idler shaft 116 which is attached to a drive crank 117 (FIG. 8). In certain embodiments, the actuator 108 is coupled eccentrically to the wiper arm 110 so as to convert at least some rotary motion of the actuator 108 to reciprocating motion of the wiper arm 110.

In certain embodiments, the wiper motor 107 can drive a drive shaft 115 while the actuator 108 can drive the idler shaft 116. In certain embodiments, the drive shaft 115 and the idler shaft 116 each drive a wiper arm 109, 110, respectively. In the illustrated embodiment, the wiper system 105 comprises two wiper arms 109, 110 and a single wiper blade 111. In the illustrated embodiment, the wiper arms 109, 110 are coupled to each other to form a single wiper which supports the wiper blade 111 in a pantograph design set-up. Of course, the disclosure is not so limited. Embodiments of the wiper system 105 can comprise any number of wiper arms 109, 110 and associated wiper blades 111 without deviating from the scope of the disclosure.

In certain embodiments, the controller 106 is communicatively coupled to the wiper motor 107 and the actuator 108. In certain embodiments, the controller 106 controls movement of the drive shaft 115 and the idler shaft 116. In certain embodiments, the controller 106 syncs movement of the drive shaft 115 with the idler shaft 116.

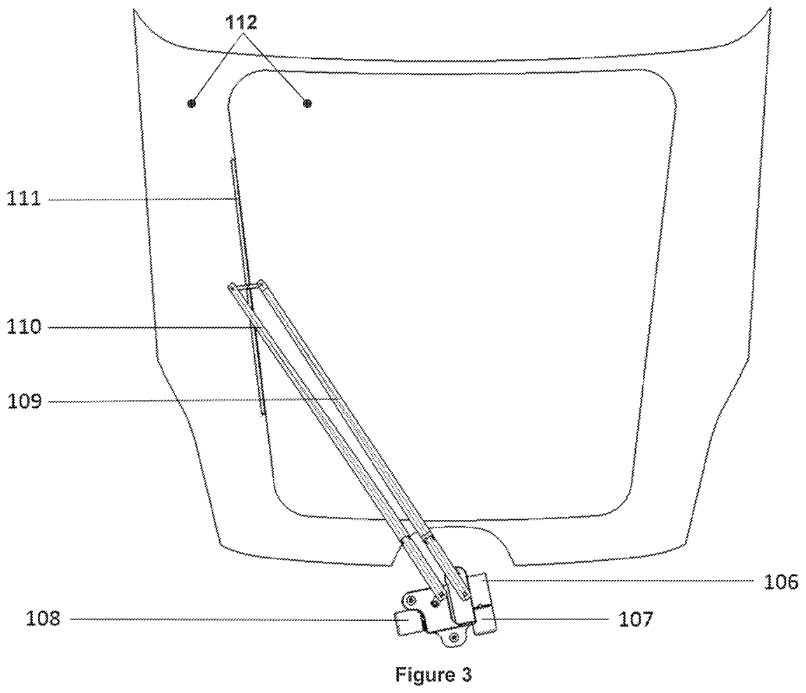

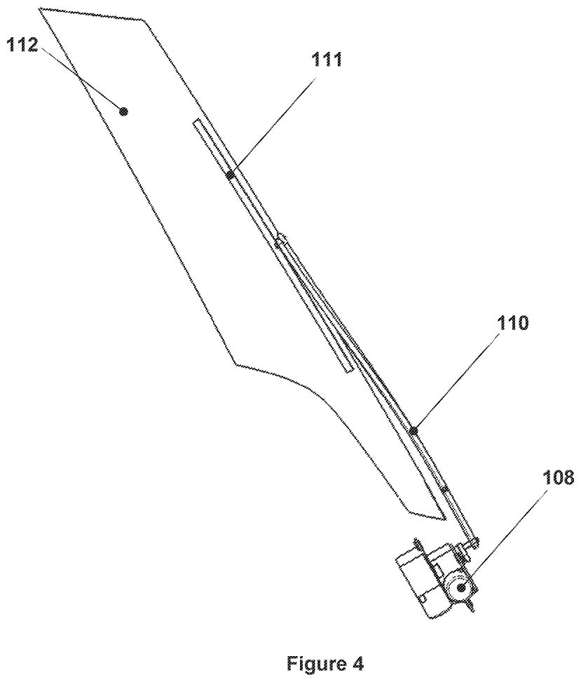

An exemplary embodiment of the wiper system 105 is shown in FIG. 3 and FIG. 4 FIG. 3 is a plan view of the windshield 112 from FIG. 2 and illustrates the wiper blade 111 of the wiper system 105 of FIG. 1 aligned with a left edge of a wiped region of the windshield 112. FIG. 4 is a side view of the windshield 112 from FIG. 3. The wiper system 105 may have a modular architecture. For example, the wiper system 105 may be a pre-assembled module, thereby mitigating the assembly time to the vehicle 100.

In certain embodiments, the controller 106 may control the wiper motor 107 and the actuator 108 to steer the wiper arms 109, 110 into the resting or parked position as well as during wiping of the windshield 112. In certain embodiments, the resting or parked position is selected so as to place the wiper arms 109, 110 and or wiper blade 111 at a location on the windshield 112 that reduces obstruction to the streamlined airflow vector of the vehicle 100.

Although not shown, the vehicle 100 may include an in-vehicle network, which provides communication channels and ports for communication between various control units, components, and/or systems of the vehicle 100, such as communication ports for exchanging data among the display 104, the controller 106 of the wiper system 105, and other associated circuitry in the vehicle 100. The in-vehicle network may facilitate access control and/or communication between the controller 106 and other ECUs, such as a telematics control unit (TCU) of the vehicle 100.

Various devices or components in the vehicle 100 may connect to the in-vehicle network, in accordance with various wired and wireless communication protocols. Examples of the wired and wireless communication protocols for the in-vehicle network may include, but are not limited to, a vehicle area network (VAN), a CAN bus, Domestic Digital Bus (D2B), Time-Triggered Protocol (TTP), FlexRay, IEEE 1394, Carrier Sense Multiple Access With Collision Detection (CSMA/CD) based data communication protocol, Inter-Integrated Circuit (I2C), Inter Equipment Bus (IEBus), Society of Automotive Engineers (SAE) J1708, SAE J1939, International Organization for Standardization (ISO) 11992, ISO 11783, Media Oriented Systems Transport (MOST), MOST25, MOST50, MOST150, Plastic optical fiber (POF), Power-line communication (PLC), Serial Peripheral Interface (SPI) bus, and/or Local Interconnect Network (LIN).

FIG. 5 illustrates exemplary vision zones 118 that may be required to be wiped per regulatory requirements. An exemplary wiped zone 119 for the wiper system 105 is also illustrated in FIG. 5 by dashed lines. As is illustrated, in certain embodiments, the wiper arms 109, 110 couple to both the drive shaft 115 of the wiper motor 107, the idler shaft 116 coupled to the drive crank 117 of the actuator 108, and the wiper blade 111. In certain embodiments, the wiper arms 109, 110 may be coupled to the wiper blade 111 along a length of the wiper blade 111 to form a single pantograph wiper. In certain embodiments, at least one of the wiper arms 109, 110 may be coupled to the idler shaft 116, and the other wiper arm 109, 110 can be coupled to the drive shaft 115 of the wiper motor 107, as shown, for example, in FIG. 5.

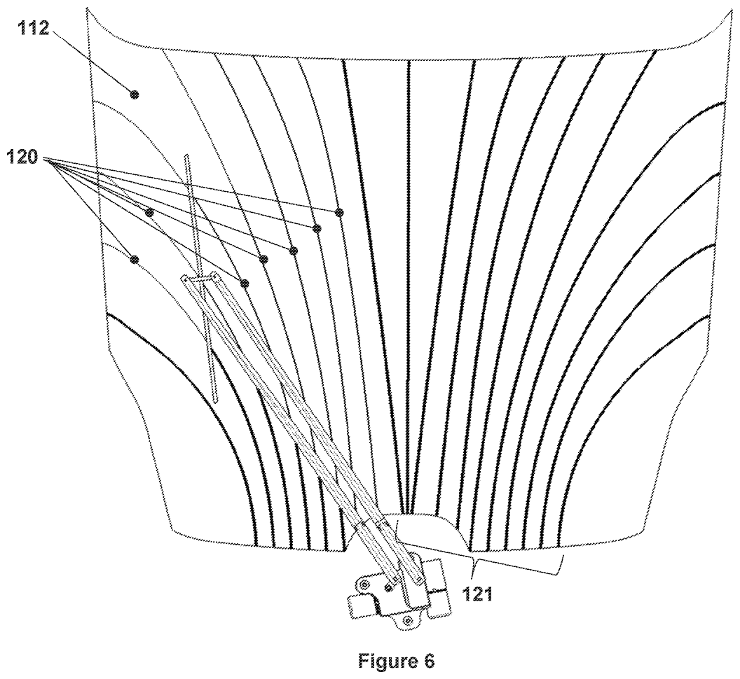

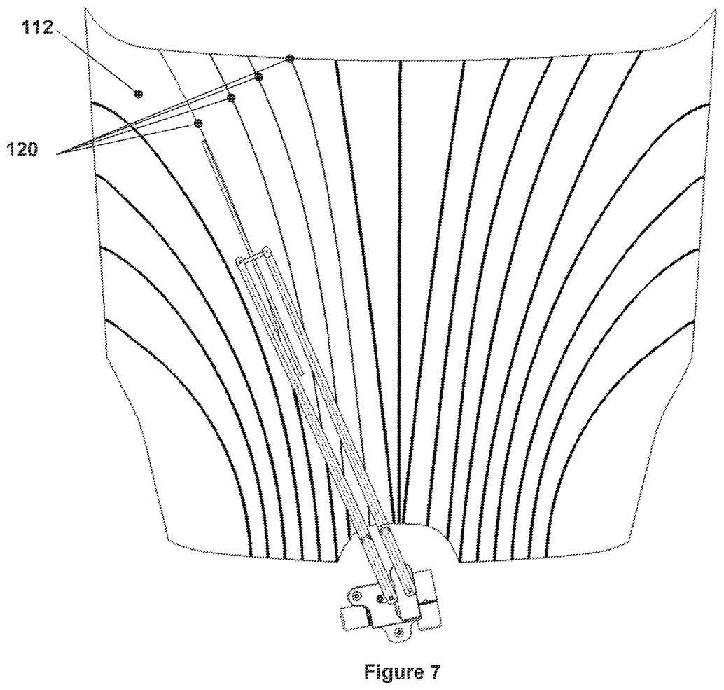

FIG. 6 illustrates a first park position for the wiper blade 111 and/or arms 109, 110 that obstructs airflow across the windshield 112. In FIG. 6, the lines 120 represent obstructed airflow and the lines 121 represent non-obstructed airflow. FIG. 7 illustrates a second park position for the wiper blade 111 and/or arms 109, 110 that improves the airflow across the windshield 112 as compared to FIG. 6. In FIG. 7, there are fewer lines 120 representing obstructed airflow.

FIG. 8 is a perspective view of at least the wiper motor 107 from the wiper system 105 of FIG. 1. In certain embodiments, the wiper system 105 includes the drive shaft 115 and the idler shaft 116. In certain embodiments, the wiper motor 107 includes a mount 122 for attaching to the vehicle 100. In certain embodiments, the wiper motor 107 can comprise a support structure 123.

In certain embodiments, the actuator 108 is affixed to the same support structure 123 as the wiper motor 107. In certain embodiments, the drive crank 117 of the actuator 108 is coupled to the idler shaft 116. In certain embodiments, the idler shaft 116 is coupled to the end of one of the wiper arms 109, 110. Based on control signals from the controller 106, the wiper arms 109, 110, and the wiper blade 111 may be stowed and/or placed at a specific wiping angle for the wiper blade 111. For example, the drive crank 117 of the actuator 108 may rotate to stow the wiper arms 109, 110, and the wiper blade 111 and/or set or change the wiping angle of the wiper blade 111. The actuator 108 may be a stepper motor, servo motor, digital-servo motor, or another motor.

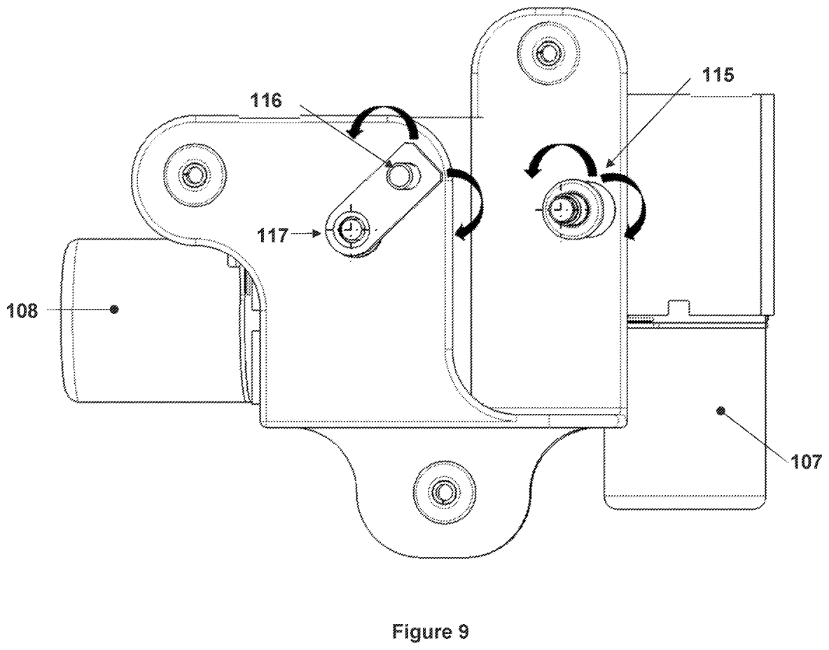

FIG. 9 is a top view of the wiper motor 107 from FIG. 8. An exemplary relationship of movement between the idler shaft 116 and the drive shaft 115 is shown in FIG. 9. In certain embodiments, the drive motor 107 and the actuator 108 collectively move the wiper arms 109, 110 of the wiper system 105 in a transverse manner across the width of the windshield 112 using rotational motion shown in FIG. 9. In certain embodiments, the wiper system 105 syncs movement of the drive shaft 115 and the idler shaft 116. In certain embodiments, the synching occurs via electronic signal communication.

In certain embodiments, the controller 106 controls the rotational motion of the drive crank 117 of the actuator 108 relative to the rotation of the drive shaft 115 which is connected to the wiper arm 109 so as to allow steering of the idler shaft 116 coupled to the wiper arm 110. In certain embodiments, the controller 106 may comprise, but is not limited to comprising, a microcontroller, an Application-Specific Integrated Circuit (ASIC) processor, a microcontroller, a state machine, and/or other processors or control circuits.

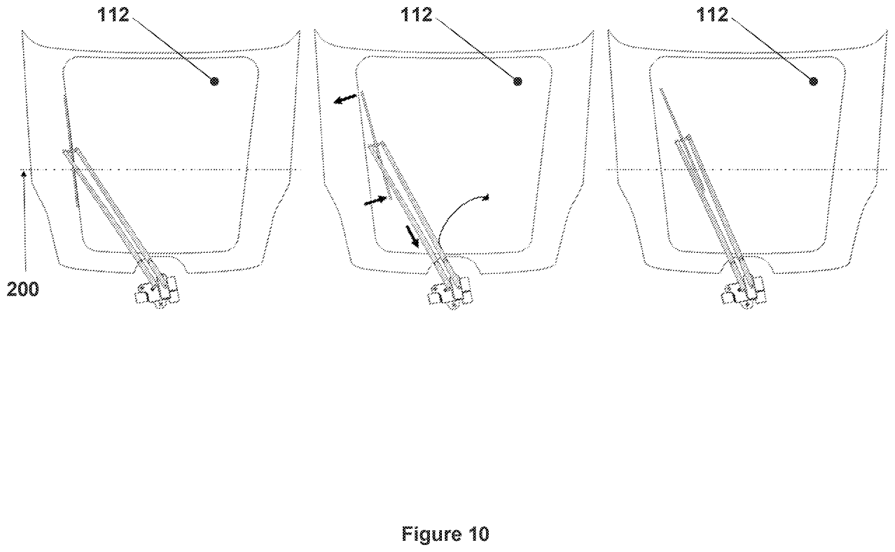

FIG. 10 illustrates a series of views (left to right) showing exemplary steps for moving the wiper blade 111 from an operational position to a non-operational or parked position. In certain embodiments, during operation, a trigger signal (or instruction) may be received at the controller 106 to initiate the stowing operation of the wiper blade 111 to the park position. The extent of movement of the wiper arms 109, 110 and the wiper blade 111 with respect to a reference axis 200 is illustrated in FIG. 10.

In certain embodiments, the controller 106 may adjust the angle of orientation of the wiper arms 109, 110 with respect to the reference axis 200 during the transverse motion of both wiper arms 109, 110 and the wiper blade 111 across the windshield 112.

In certain embodiments, the actuator 108 determines the angular displacement of the wiper arms 109, 110. For example, the wiper blade 111 may be inclined at a “45 degree” angle to a windshield centerline when not in use. However, when operating, the wiper blade 111 may be inclined at a specific orientation angle, such as “90 degrees” with respect to the reference axis 200. In certain embodiments, after the specific orientation angle is set for the wiper blade 111 and the wiper arms 109, 110, the wiper motor 107 moves the wiper arms 109, 110 along the length of the windshield 112. In certain embodiments, the controller 106 control the supply of current/power to both the actuator 108 and the wiper motor 107, varying the power output to each of them as a function of time. In certain embodiments, the wiper system 105 makes pantograph and 4-bar link style wiper systems more efficient than traditional ones when comparing sensitivities of vehicle design to aerodynamic drag and wipe quality. These advantages enable users to increase the range of their vehicle while also having a quieter and safer driving experience.

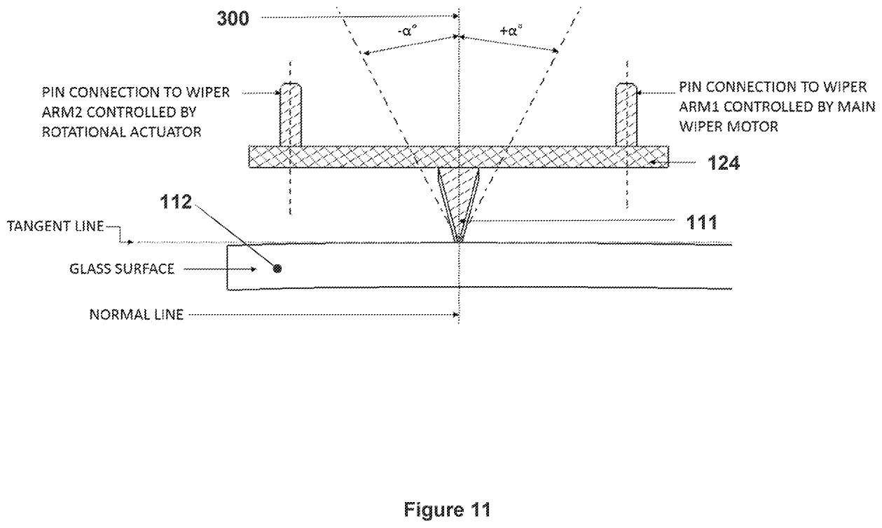

FIG. 11 illustrates an attack angle optimization technique performed by the wiper system 105 of FIG. 1 to reorient the wiper blade 111 on the windshield 112 surface during dynamic wiping conditions (e.g., operational). In certain embodiments, the inclination angle for the wiper arms 109, 110 or wiper blade 111 may be adjusted within a range (for example, “−5° to +5°” with respect to the reference axis 300). Levelling plate 124 is illustrated in FIG. 11. Of course, the disclosure is not so limited. Embodiments of the wiper system 105 can be adjusted within any range without deviating from the scope of the disclosure. In certain embodiments, the inclination angle may be adjusted on the basis of type of contaminant, wetness/dryness of the windshield and weather conditions to enhance wipe quality and minimize blade flip-over noise.

In certain embodiments, during wiping of the windshield 112, a trigger signal dynamically adjusts the attack angle. Based on the received trigger signal, the controller 106 may generate and transmit control signals (or control instructions) to the power module 103 to provide specific power to the actuator 108. In certain embodiments, the trigger signal may be received at the controller 106 based on a user input. For example, a user of the vehicle 100 may switch “ON” the wiper park switch or select a UI control on the UI 102 via the display 104, to start the operation of the wiper system 105.

In certain embodiments, in response to the received trigger signal, the controller 106 positions the wiper blade 111 attached to the wiper arms 109, 110 at a specific orientation angle. For example, in certain embodiments, the orientation angle can be approximately “45°” (i.e., a slanted position) with respect to a longitudinal axis of the windshield 112 as a primary function. The wiper blade 111 may be positioned at the specific orientation angle from a previous position, for example, an orientation angle near “90°” (e.g., in the active wiping mode). Of course, the disclosure is not so limited. Embodiments of the wiper system 105 can be adjusted to any orientation angle without deviating from the scope of the disclosure. In certain embodiment, the actuator 108 can position the wiper blade 111 at the specific orientation angle with respect to the longitudinal axis by re-positioning the idler shaft 116 attached to one of the arms 109, 110. Based on the received trigger signal, the actuator 108 may re-position the idler shaft 116 appropriately.

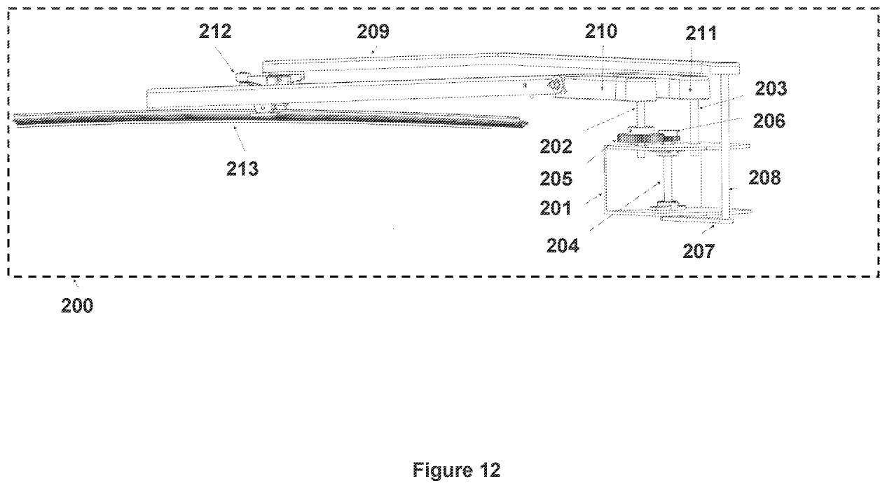

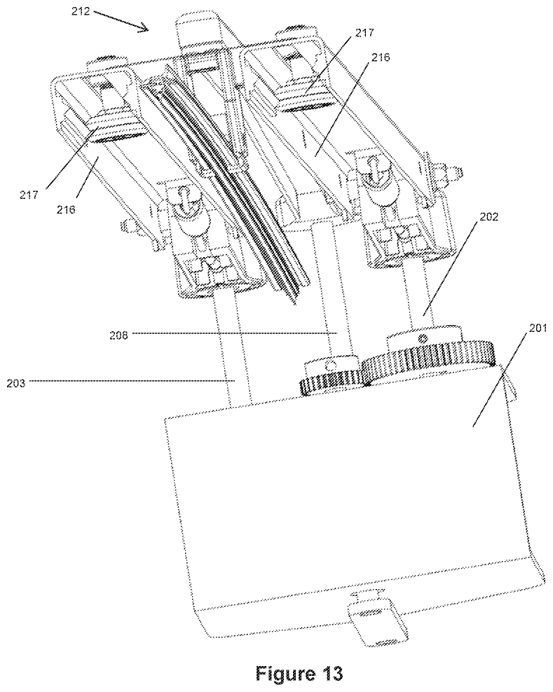

FIGS. 12 and 13 depict a slider-crank wiping mechanism 200 with variable curvilinear blade sweep for a pantograph wiper system from an isometric point of view, in accordance with an embodiment of the present disclosure. In certain embodiments, the slider-crank wiping mechanism 200 may have a modular architecture that can be readily installed in a vehicle 214. In certain embodiments, the slider-crank wiping mechanism 200 comprises a wiper-arrangement that may include two drive pivot shafts 203 coupled to the wiper motor output. In certain embodiments, the slider-crank wiping mechanism 200 comprises an idler pivot shaft 204 coupled to one of the drive pivot shafts 203 via a gear train. In certain embodiments, the slider-crank wiping mechanism 200 comprises a reciprocating crank 207 and reciprocating shaft 208 that couple the idler pivot shaft 204 to a middle wiper arm 209, two wiper arms 210, 211, a wiper blade 213, and an arm-blade coupler 212 that connects all three wiper arms 209, 210, 211 to the wiper blade 213. The aforementioned components may be assembled together to form a pantograph wiper system with the slider-crank wiping mechanism for variable curvilinear blade sweep.

In certain embodiments, the slider-crank wiping mechanism 200 may utilize two degrees of freedom, one of which is a pure translational motion along an axis parallel to either wiper arm 209 or wiper arm 210 as shown in FIG. 12. The other degree of freedom can be pure rotational motion about an axis concentric with the reciprocating shaft 208. In certain embodiments, the vector addition of the translational motion and the rotational motion at any instant in time allows the wiper blade 213 to sweep across a larger area during one period of the wiping cycle. In other words, in certain embodiments, the slider-crank wiping mechanism 200 can allow the wiper blade 213 to traverse up and down across the windshield 215 while simultaneously traversing left and right, allowing for greater coverage of the vision zones and an enhanced cleanability of the windshield 215. Such a slider-crank wiping mechanism 200, despite having a two degree of freedom output motion, may only need one degree of freedom input from a single motor, which makes the slider-crank wiping mechanism 200 a cost-effective wiper system for windshields 215 with large height-to-width aspect ratio when compared to other alternative wiper systems, including but not limited to traditional pantograph wiper systems and four-bar linkage wiper systems.

The operation of the simultaneous translational and rotational motion occurring in the slider-crank wiping mechanism 200 is illustrated in FIG. 12. A motor housing 201 may house a motor (not shown). In certain embodiments, the motor drives two shafts, namely drive pivot shaft 202 and drive pivot shaft 203, in synchronous alternating rotational motion. In certain embodiments, the drive pivot shaft 202 may be attached to a wiper arm 210, and the drive pivot shaft 203 may be attached to a wiper arm 211. In certain embodiments, an idler pivot shaft 204, not directly connected to the motor, may be coupled with either one of the drive pivot shafts 202, 203 via a gear train.

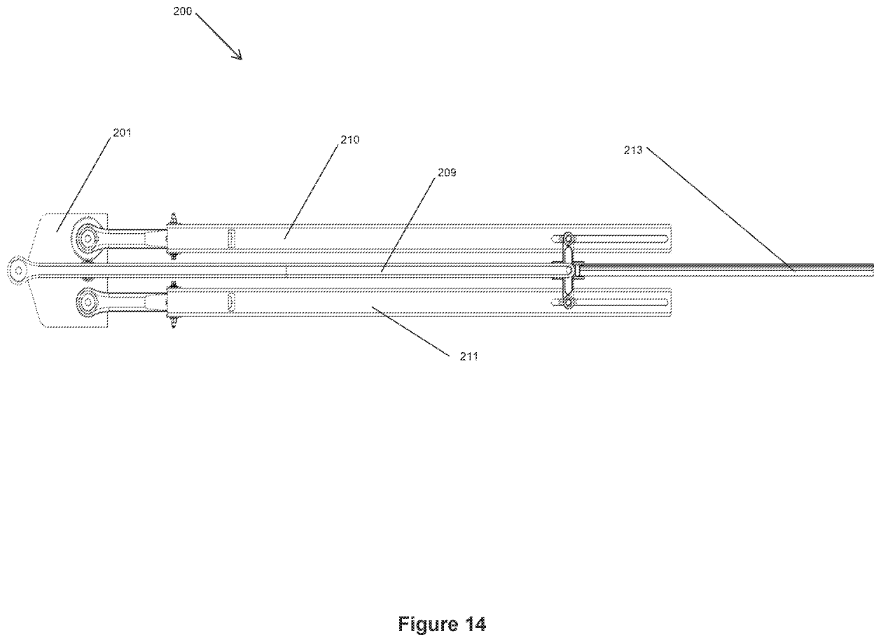

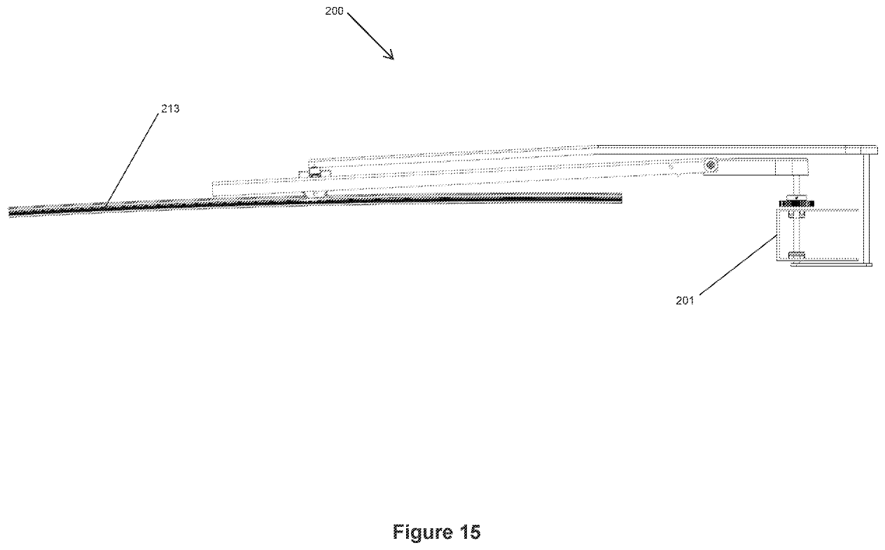

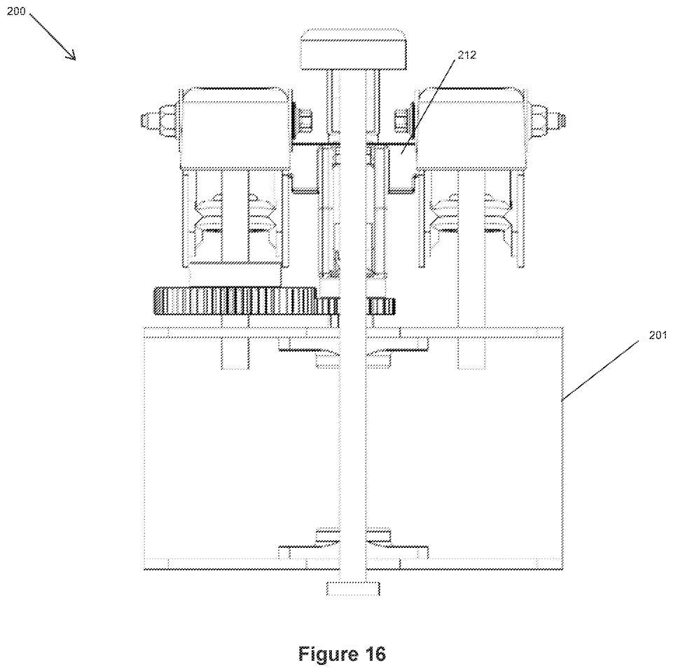

FIG. 14 is a top view of the slider-crank wiping mechanism 200 from FIG. 12. FIG. 15 is a side view of the slider-crank wiping mechanism 200 from FIG. 12. FIG. 16 is a rear view of the slider-crank wiping mechanism 200 from FIG. 12. In certain embodiments, the gear train comprises a drive gear 205 and an idler gear 206 or any number and/or combination of gears. In certain embodiments, the motion of the idler pivot shaft 204 is coupled to the wiper middle arm 209 via a reciprocating crank 207 and a reciprocating shaft 208. In certain embodiments, the middle wiper arm 209 is connected to the wiper blade 213 and the wiper arm 210 and the wiper arm 211 via the arm-blade coupler 212.

In certain embodiments, when power is sent from the vehicle 214 to drive the wiper motor, the motor in turn transmits rotary motion to drive both drive pivot shaft 202 and drive pivot shaft 203. In certain embodiments, the synchronous alternating rotary motion of both drive pivot shafts 202, 203 forces wiper arm 210 and wiper arm 211 to follow in a similar oscillatory fashion.

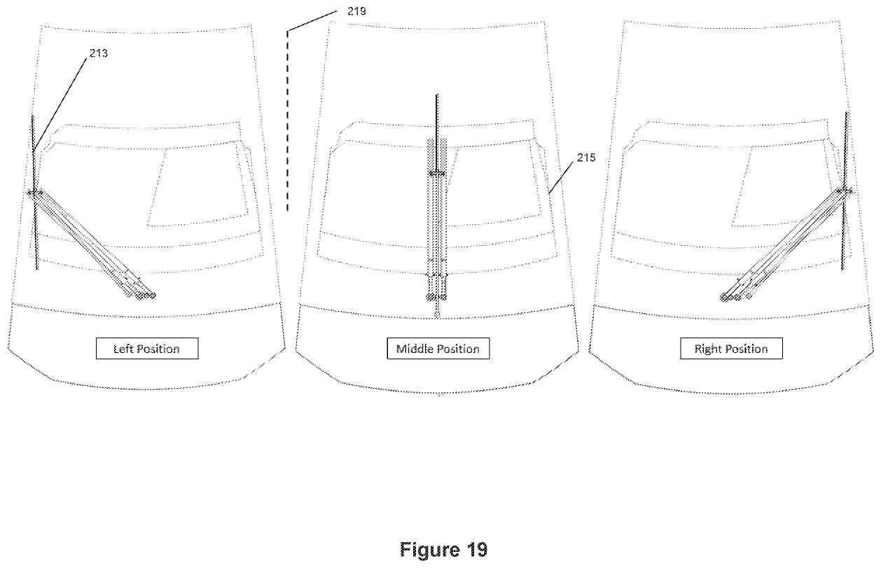

In certain embodiments, the arm-blade coupler 212 may affix both wiper arm 210 and wiper arm 211 to the wiper blade 213. In certain embodiments, the coupler 212 may only allow relative rotation between wiper arm 210 (or arm 211) and itself but constrain any relative rotation between itself and the wiper blade 213. This constraint forces the wiper blade 213 to maintain parallelism with reference axis Alpha 219 (FIG. 19) as wiper arm 210 and arm 211 rotate back and forth. In certain embodiments, the interplay between the drive pivot shafts 202, 203, the wiper arms 209 and 210, the wiper blade 213, and the arm-blade coupler 212 gives rise to one degree of freedom for the pantograph wiper system. In this way, the system provides a rotational motion with the ability to sweep the windshield 215 from left to right and vice versa in an alternating manner.

In certain embodiments, the second degree of motion for the slider-crank wiping mechanism 200 employs a slider and gear system integrated in the pantograph wiper system. As illustrated in FIG. 12, the idler pivot shaft 204 can connect to the idler gear 206 and mate with the drive gear 205 that is directly driven by drive pivot shaft 202 (or alternatively to shaft 203). In certain embodiments, the opposite end of the idler pivot shaft 204 may connect to the wiper middle arm 209 via a reciprocating crank 207 and a reciprocating shaft 208. In certain embodiments, the gear train offers two functions. For example, a first functionality can be to control the relative direction of rotation between the wiper arms 210 and 211 and the middle arm 209.

As is illustrated, in certain embodiments, the gear train consists of two gears to offer opposite relative motion. In certain embodiments, the wiper arms 210 and 211 rotate clockwise, the middle arm 209 rotates counterclockwise and vice versa. For example, a second functionality of the gear train can be to vary the speed ratio between the wiper arms 210 and 211 and the middle arm 209, which effectively controls the angular position of the middle arm 209 with respect to wiper arm 210 and 211 at any given instant in time. In the illustrated embodiment, a gear ratio of two has been used in particular for reasons explained below. Of course, the disclosure is not limited to a gear ratio of two. In other embodiments the gear train can have a ratio of 1.5, 2.5, 3.0, etc.

In certain embodiments, the arm-blade coupler 212, from which the wiper middle arm 209 extends to the reciprocating shaft 208, is not locked in orientation to the wiper arms 210 and 211. Instead, the arm-blade coupler 212 rests on two integrated guide tracks 216 inside the arms 210, 211 via two rollers 217. In certain embodiments, the two rollers 217 are incorporated into the arm-blade coupler 212 and constrain it to only slide up and down along the integrated tracks 216 on the arms 110 and 111.

In certain embodiments, the configuration of the reciprocating crank 207 and shaft 208, the middle arm 209, the roller 217, and the integrated track 216 in either wiper arm 110 or 111 essentially forms a four-bar crank-slider mechanism. In certain embodiments, the four-bar crank-slider mechanism converts the rotational motion of the idler pivot shaft 204 into linear motion of the wiper blade 213, achieving the second degree of freedom of the slider-crank wiping mechanism.

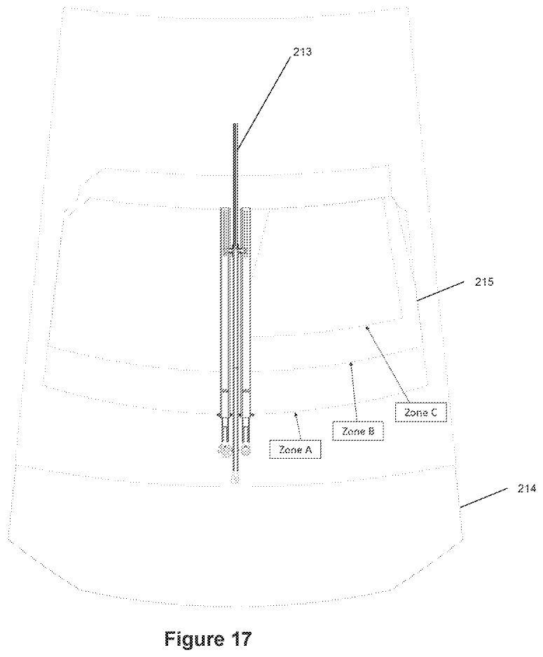

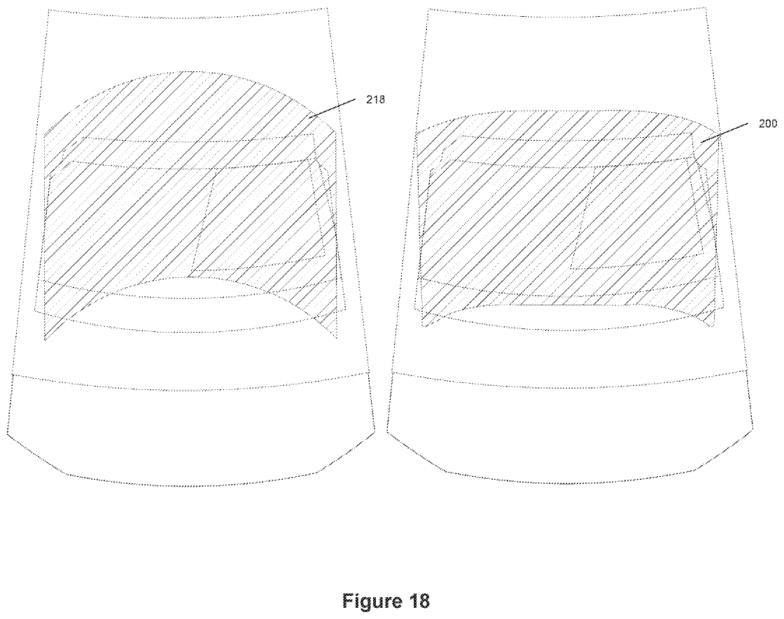

FIG. 17 shows a pantograph wiper system with the slider-crank wiping mechanism 200 installed on a vehicle with a large height-to-width windshield dimensions as well as typical vision zones (e.g., Zone A, Zone B, and Zone C) that need to be covered by the wiper system as per regulatory requirements. FIG. 18 provides a comparison between the wiping sweep of a traditional pantograph wiper system 218 versus that of a pantograph wiper system with the slider-crank wiping mechanism 200. The vector summation of the rotational motion of the blade 213 as well as its linear motion may be traced out simultaneously to generate a variable wiping sweep as is presented in the right drawing of FIG. 18. In certain embodiments, the slider-crank wiping mechanism 200 offers a much larger swept area of the vision zones due to its ability to systematically adjust the radius of arc of the blade 213 sweep. In contrast, a traditional pantograph wiper system can only provide a blade sweep with a constant radius of arc hindering it from covering certain portions of the large height-to-width windshield.

FIG. 19 illustrates three different positions of a pantograph wiper system with the slider-crank wiping mechanism 200 as it sweeps across the windshield. The combined effect of the two degrees of freedom of the disclosed embodiment can be understood by collectively observing FIGS. 17-19. If it is to be assumed that the starting default position of the blade 213 is on the left of the windshield 215, then it follows that in one cycle of the wiper arms 110 and 111, the blade 213 sweeps across the windshield 215 from left to right and back again to its starting position. During that one cycle of rotational motion, the blade would follow an arc with a constant radius of curvature if the blade was to be attached to a traditional pantograph wiper system 218, as is the case shown on the left side of FIG. 18. In that scenario, there would be a large portion of the top windshield untouched by the blade when the blade resides in the left and right extrema, and there would be a large portion of the bottom windshield untouched by the blade when the blade is in the center position. This may lead to suboptimal cleanability of the windshield; therefore, it is desired to simultaneously move the blade linearly up and down across the windshield to cover the remaining untouched spots.

Referring to the right side of FIG. 18, during the one cycle of rotational motion of the blade 213 across the windshield 215 from left to right to left, the slider-crank wiping mechanism 200 may allow the blade 213 to travel from top level on left side to bottom level in the center to top level again on right side and back in reverse motion to bottom level in the center to top level on left side. This means that the linear motion of the blade 213 may have a time period that is twice the time period of its rotational motion, and hence a gear ratio of two has been selected in this embodiment.

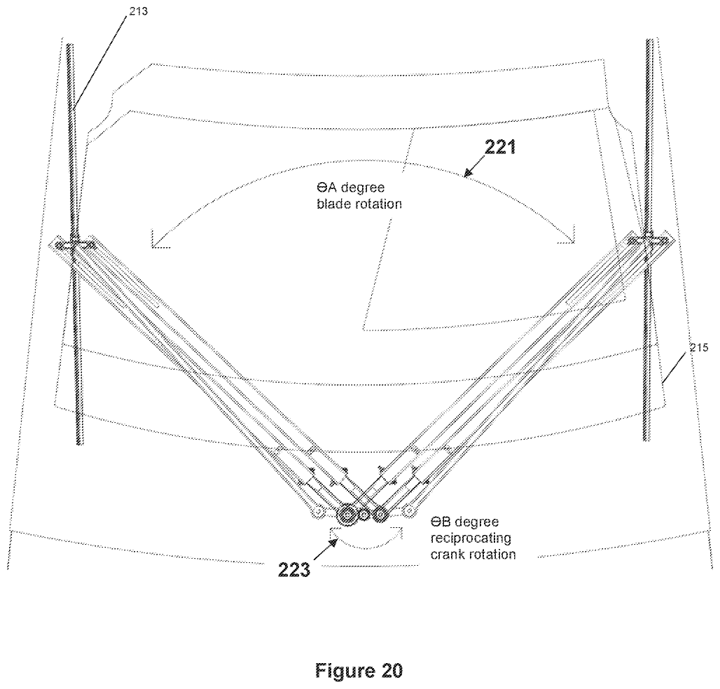

FIG. 20 illustrates the extrema positions of a pantograph wiper system with the slider-crank wiping mechanism 200 on a windshield 215 with a large height-to-width aspect ratio. In certain embodiments, one period of rotational motion, the blade 213 sweeps an angle of 0 degrees as it traverses the windshield 215 from left to right and back to starting position, for a total swept angle of 188 degrees. In certain embodiments, OA 221 is 94 degrees. In certain embodiments, OA 221 is 82 degrees. In certain embodiments, OA 221 is another value.

Because of the gear meshing ratio of two between the drive gear 205 and idler gear 206, the reciprocating crank 207 and shaft 208 may rotate OB degrees 223 in only half the time period. In certain embodiments, OB 223 is 188 degrees. In certain embodiments, OB 223 is 180 degrees. In certain embodiments, OB 223 is another value.

In certain embodiments, the rotational motion of the reciprocating crank 207 and shaft 208 is then converted into a reciprocating linear motion of the blade 213 via the crank-slider wiping mechanism 200 with twice the time period of the rotational motion of the blade 213.

As the blade 213 rotates from left side to center position, the reciprocating crank 207 rotates from approximately a horizontal orientation to a vertical orientation. In certain embodiments, the downwards sweeping motion of the reciprocating crank 207 from horizontal to vertical stance in this brief instance in time momentarily shifts the pivot axis of the reciprocating shaft 208 and the middle arm 109 downwards, forcing the rollers 217 attached to the arm-blade coupler 212 to slide linearly down along the integrated tracks 216 on wiper arms 110 and 111. This effectively pulls the blade 213 downwards across the windshield 215 to cover the bottom central area of the windshield 215 that might have been left untouched if the blade 213 had a constant arc radius. During the next portion of the blade 213 sweep from central position to right position, the process is reversed; the reciprocating crank 207 rotates from vertical stance back to an approximately horizontal stance, effectively sliding the two rollers 217 up along the tracks 216 and pushing the blade 213 back upwards across the windshield 215.

In certain embodiments, the process of the reciprocating crank 207 pushing and pulling the blade 213 up and down on the windshield 215 may repeat once again on the returning sweep of the blade 213 from right side to left side, occurring at a frequency twice that of the rotational motion of the blade 213. In certain embodiments, the amplitude of the linear motion of the blade 213, on the other hand, is a function of the reciprocating crank 207 length. In certain embodiments, the longer the reciprocating crank 207, the larger the delta change in the position of the pivot axis of the middle arm 209 and the further up and down the rollers 217 may travel across the tracks 216. In certain embodiments, the reciprocating crank 207 length is 250 mm. In certain embodiments, a length of 250 mm was the optimal linear motion of the blade 213 with respect to the windshield 215 dimensions. Of course, the length is not limited to the listed length and can have any another value.

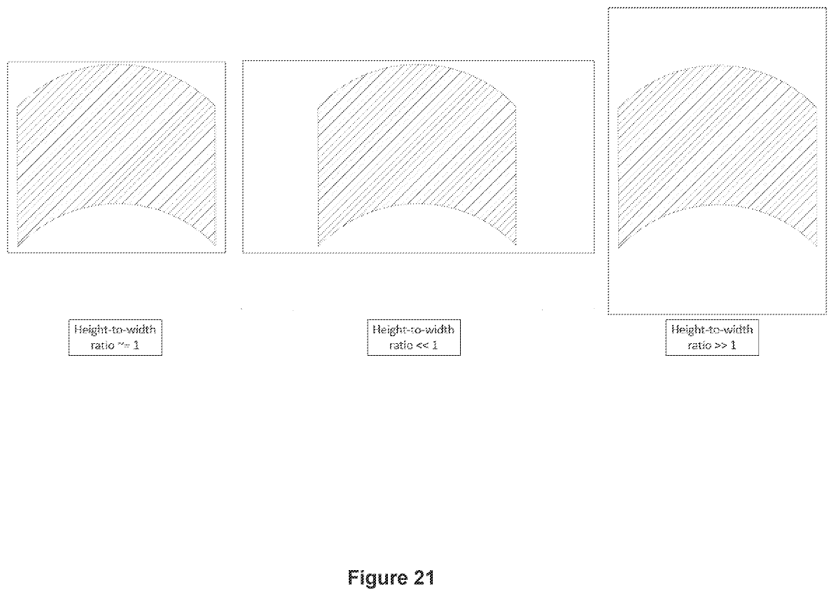

FIG. 21 illustrates the wiping sweep of a traditional pantograph wiper system on three different windshield sizes: a height-to-width aspect ratio close to one, a height-to-width aspect ratio significantly smaller than one, and a height-to-width aspect ratio significantly larger than one.

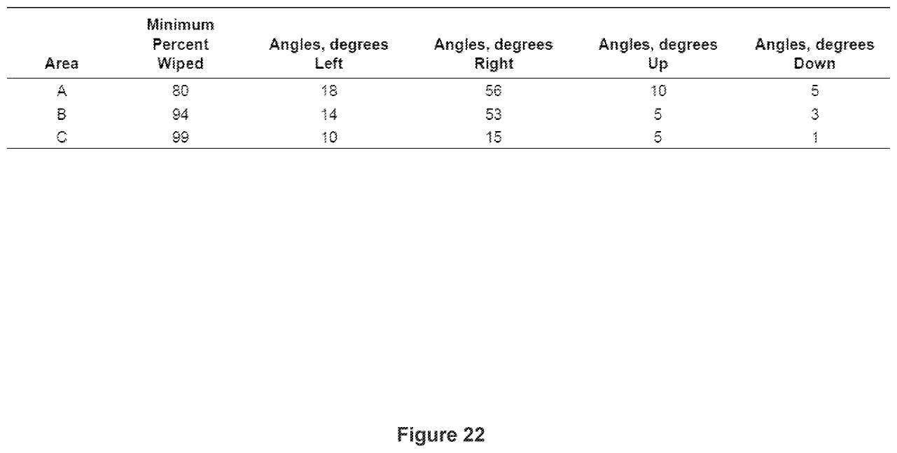

FIG. 22 illustrates SAE Vehicle Safety Recommended Practice J942 standards for the minimum wiped area requirements as a percentage of three different vision zones (A, B, C), defined by four planes projecting from the eyellipse at certain angles.

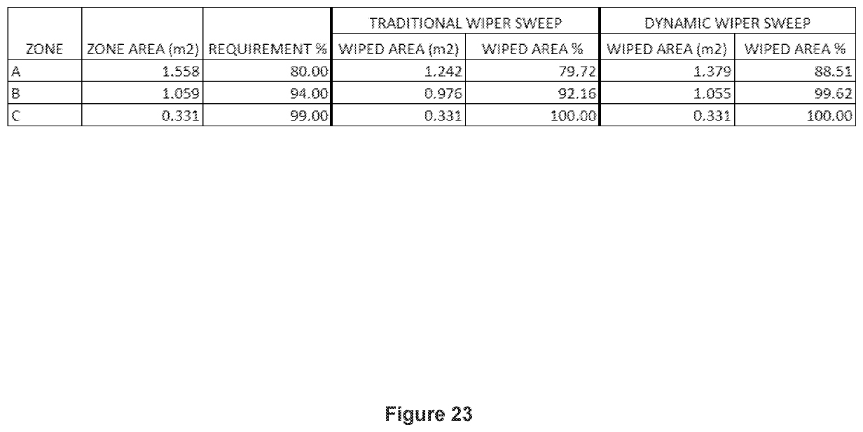

FIG. 23 includes a table that compares the effective wiping sweep of the pantograph wiper system disclosed herein versus a traditional pantograph wiper system for a hypothetical windshield with a large height-to-width ratio. The table provides a quantitative comparison between the slider-crank wiping mechanism 200 for a pantograph wiper system versus a traditional pantograph wiper system. As indicated in the table, the slider-crank wiping mechanism 200 for a pantograph wiper system has the potential to surpass the cleanability performance of the traditional pantograph wiper system. In certain embodiments, the slider-crank wiping mechanism 200 is an ideal candidate for windshields with large height-to-width aspect ratio as a result of its relatively low cost, smallest packaging footprint inside a vehicle environment, and highly optimizable wiping sweep pattern for enhanced cleanability.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed glove box actuation assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. A wiper system for wiping a windshield, comprising:
a first wiper arm and a second wiper arm both supporting at least one wiper blade;
a wiper motor configured to drive rotation of at least the first wiper arm; and
an actuator coupled eccentrically to the second wiper arm so as to convert rotary motion of the actuator to reciprocating motion of the second wiper arm.

2. The wiper system of claim 1, further comprising a controller configured to control rotational motion of at least the actuator so as to cause selective rotation of the at least one wiper blade relative to the first wiper arm and the second wiper arm.

3. The wiper system of claim 2, wherein the selective rotation is to a park position.

4. The wiper system of claim 2, wherein the selective rotation steers the at least one wiper blade as the at least one wiper blade traverses the windshield.

5. The wiper system of claim 2, wherein the selective rotation sets the at least one wiper blade at a pre-defined angle of orientation.

6. The wiper system of claim 2, wherein the selective rotation changes an angle of inclination of the first wiper arm and the second wiper arm as the at least one wiper blade traverses the windshield.

7. The wiper system of claim 1, further comprising a drive crank coupled between the actuator and the second wiper arm.

8. A wiper assembly for pantograph or 4-bar link style wipers, the pantograph or 4-bar link style wipers having a first wiper arm and a second wiper arm both supporting at least one wiper blade, the wiper assembly comprising:
a wiper motor configured to drive rotation of the first wiper arm and drive rotation of the second wiper arm via the first wiper arm across a windshield; and
an actuator coupled to the second wiper arm and configured to extend and retract the second wiper arm in a direction that is generally perpendicular to a direction of motion of the first wiper arm.

9. A wiper system for pantograph or 4-bar link style wipers, the pantograph or 4-bar link style wipers having a first wiper arm and a second wiper arm both supporting at least one wiper blade, comprising:
a wiper motor having a drive shaft coupled to the first wiper arm;
a rotational actuator having a drive crank and an idler shaft, the idler shaft being coupled to the second wiper arm, and
a controller configured to control rotational motion of the drive shaft and of the rotational actuator so that the first and second wiper arms are steered, back and forth across a length of a windshield.

10. The wiper system of claim 9, wherein the controller is configured to position the wiper blade at pre-defined angle of orientation on the windshield.

11. The wiper system of claim 9, wherein the controller is configured to re-adjust a position of the idler shaft to change an angle of inclination of at least the wiper blade with respect to a reference axis during transverse motion of the first and second wiper arms across the length of the windshield.

12. A pantograph wiper system for a vehicle, comprising:
a first pivot drive shaft
a first wiper arm configured to be driven by the first pivot drive shaft;
a second pivot drive shaft;
a second wiper arm configured to be driven by the second pivot drive shaft;
a wiper motor configured to drive rotation of the first and second pivot drive shafts;
an idler pivot shaft coupled to one of the first or second pivot drive shafts;
a wiper middle arm;
a reciprocating crank and a reciprocating shaft configured to transmit rotational motion of the idler pivot shaft to the wiper middle arm; and
an arm-blade coupler connecting the wiper middle arm to the first and second wiper arms, the arm-blade coupler being configured to allow the wiper middle arm to slide along the first and second wiper arms.

13. The pantograph wiper system of claim 12, wherein each of the first and second wiper arms comprises a track, and wherein the arm-blade coupler comprises a plurality of rollers configured to slide up and down along a length of each track.

14. The pantograph wiper system of claim 12, further comprising a wiper blade coupled to the wiper middle arm, wherein a sweep of the wiper blade has a variable curvilinear shape.

15. The pantograph wiper system of claim 12, wherein rotational motion of the first and second wiper arms is synched with linear motion of the arm-blade coupler.

16. The pantograph wiper system of claim 12, wherein the wiper motor is a single wiper motor.

17. The pantograph wiper system of claim 12, further comprising a gear train.

18. The pantograph wiper system of claim 17, wherein the gear train comprises a drive gear and an idler gear.

19. The pantograph wiper system of claim 17, wherein a ratio provided by the gear train is two.

20. The pantograph wiper system of claim 17, wherein the gear train is configured to propel the reciprocating crank and the reciprocating shaft at twice a rotational speed of the first and second drive pivot shafts in an opposite direction.

21. The pantograph wiper system of claim 13, wherein a rotational motion of the reciprocating crank and the reciprocating shaft is converted to linear motion of the plurality of rollers.

22. A wiper system comprising:
a wiper motor;
a first wiper arm and a second wiper arm configured to be driven by the wiper motor;
a wiper middle arm; and
an arm-blade coupler connecting the wiper middle arm to the first and second wiper arms, the arm-blade coupler being configured to allow the wiper middle arm to slide along the first and second wiper arms.

23. The wiper system of claim 22, wherein the wiper motor is a single wiper motor.

24. The wiper system of claim 22, wherein the wiper middle arm slides along at least a portion of a length of the first and second wiper arms.

25. The wiper system of claim 22, wherein each of the first and second wiper arms comprises a track, and wherein the arm-blade coupler comprises a plurality of rollers configured to slide up and down along a length of each track.

26. The wiper system of claim 22, wherein the wiper system is configured as a pantograph wiper system.

27. The wiper system of claim 22, further comprising a wiper blade coupled to the wiper middle arm, wherein a sweep of the wiper blade has a variable curvilinear shape.

28. The wiper system of claim 22, wherein rotational motion of the first and second wiper arms is synched with linear motion of the arm-blade coupler.

29. The wiper system of claim 22, further comprising a gear train.

30. The wiper system of claim 29, wherein the gear train comprises a drive gear and an idler gear.

31. The wiper system of claim 29, wherein a ratio provided by the gear train is two.

32. The wiper system of claim 29, wherein the gear train is configured to vary a speed ratio between the first and second wiper arms and the middle arm.

33. The wiper system of claim 29, wherein the gear train is configured to control an angular position of the middle arm with respect to first and second wiper arms.

34. A method for wiping a windshield, comprising:
providing at least one wiper blade supported by a first wiper arm and a second wiper arm;
rotating at least the first wiper arm; and
converting rotary motion to reciprocating motion of the second wiper arm.

35. The method of claim 34, further comprising controlling the rotary motion so as to cause selective rotation of the at least one wiper blade relative to the first wiper arm and the second wiper arm.

36. The method of claim 35, wherein the selective rotation is to a park position.
